(19) United States
(12) Patent Application Publication
(10) Pub. No.: US 2019/0380528 A1
(43) Pub. Date: Dec. 19, 2019

(54) Coffee Machine With Perfected Coffee Dispenser

(71) Applicant: De'Longhi Appliances S.R.L., Treviso (IT)

(72) Inventors: Giuseppe De'Longhi, Treviso (IT); Enrico Zaratin, Paese (Treviso) (IT)

(21) Appl. No.: 16/464,440

(22) PCT Filed: Nov. 27, 2017
(86) PCT No.: PCT/EP2017/080489

§ 371 Date: May 28, 2019

(30) Foreign Application Priority Data
Nov. 28, 2016 (IT) 102016000120182

(51) Int. Cl. A47J 31/44; A47J 31/46; A23F 5/24

(52) U.S. Cl. CPC A47J 31/4482; A23F 5/24; A47J 31/46

(57) ABSTRACT

The coffee machine (1) comprises a coffee dispenser having a support (3), a first spout (4) for dispensing coffee supported by the support (3), at least a second spout (5) for dispensing coffee supported by the support (3), the support (3) having translation guides for translating the first and the second spout (4, 5) in the direction (L) of the width of the machine (1), and a gear for synchronising the translation movement in the opposite sense to the first and second dispensing spout (4, 5) in the direction (L) of the width of the machine (1).

The present invention relates to a coffee machine equipped with a coffee dispenser having frontally a support sustaining at least two coffee dispensing spouts.

One of the problems encountered in the use of such coffee machines of the known type is represented by the difficulty or sometimes the impossibility to manage different heights of cups under the coffee dispenser because of the insufficient distance present between the coffee dispensing spouts and the resting surface for the cups.

To obviate this drawback many coffee machines are equipped with a coffee dispenser height adjustment system.

However, this solution does not solve the problem of the centring of the coffee in the cup according to whether the machine is dispensing into a single cup or simultaneously into two cups and also according to the size of the cups.

This drawback has been resolved by providing movement mechanisms that change the distance between the dispensing spouts in the direction of the width of the coffee machine.

Such movement mechanisms of the known type may however be rather complex and not very precise in their adjustment and can involve trajectories of components that require space that is not always available also considering the current trend to reduce the dimensions of coffee machines as much as possible.

The technical task of the present invention is, therefore, to provide a coffee machine which obviates the above-described technical drawbacks of the prior art.

Within the context of this technical task an object of the invention is to realise a coffee machine equipped with an alternative system for moving the coffee dispensing spouts so as to improve the centring of the coffee in the cup.

Another object of the invention is to realise a coffee machine equipped with a system for moving the coffee dispensing spouts that allows simple and precise manual adjustment of the relative position between the coffee dispensing spouts.

Another object of the invention is to realise a coffee machine equipped with a system for moving the coffee dispensing spouts that can be unfolded in extremely reduced spaces.

The technical task, as well as these and other objects, according to the present invention, are reached by realising a coffee machine comprising a coffee dispenser having a support, a first spout for dispensing coffee supported by said support, at least a second spout for dispensing coffee supported by said support, characterised in that said support has translation guides for translating said first and said second spout in the direction of the width of the coffee machine, and a gear for synchronising the translation movement in the opposite sense to said first and second dispensing spout in the direction of the width of the coffee machine.

For the centring of the coffee in the cup a gear is therefore used that advantageously allows the dispensing spouts to be moved exclusively along the width direction of the machine without changing their orientation.

Consequently, for the centring in the cup a movement is performed that does not change the dimensions of the machine in the height and depth direction.

Advantageously, a deceleration means for decelerating the movement of said gear is also provided.

As well as stabilising the positions achieved by the dispensing spouts in their stroke, the deceleration means contributes to improving the perception of the movement by the user who manually pulls a dispensing spout to activate the gear.

The present invention also discloses a centring method of the dispensing of coffee in a coffee machine comprising at least two spouts for dispensing coffee, characterised in that it consists of translating in the opposite sense in a synchronised way said two spouts, in the direction of the width of the coffee machine maintaining their axis permanently oriented in the direction of the height of the coffee machine, between a position of maximum mutual distance in the direction of the width of the coffee machine, and a position of minimum mutual distance in the direction of the width of the coffee machine.

Other characteristics of the present invention are further defined in the claims hereinbelow.

Further characteristics and advantages of the invention will become more apparent from the description of a preferred, but not exclusive, embodiment of the coffee machine according to the invention, which is illustrated by way of approximate and non-limiting example in the attached drawings, of which:

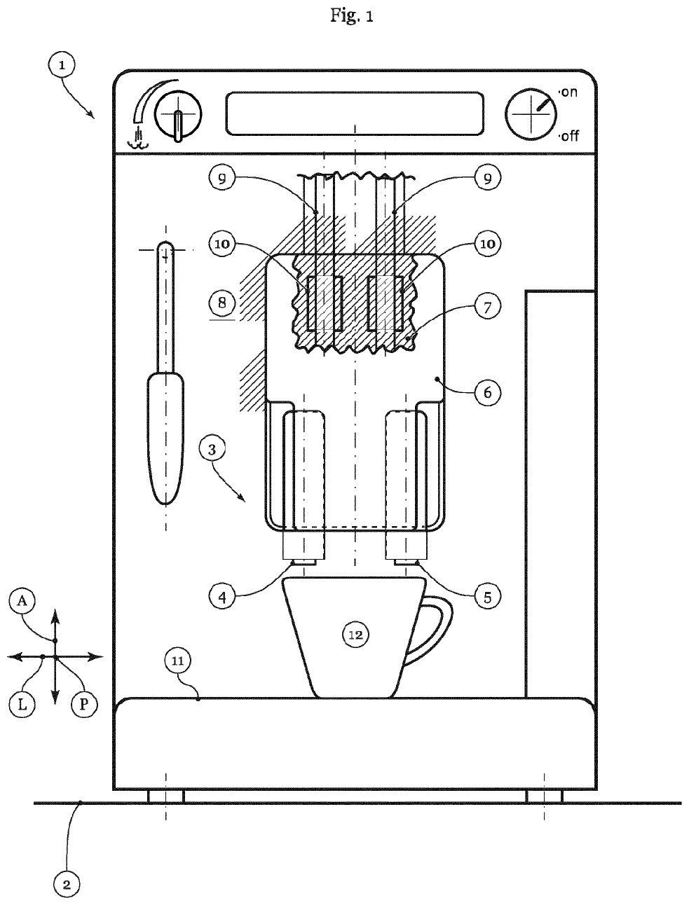

FIG. 1 schematically shows a front view of the coffee machine with the coffee dispensing spouts near to each other;

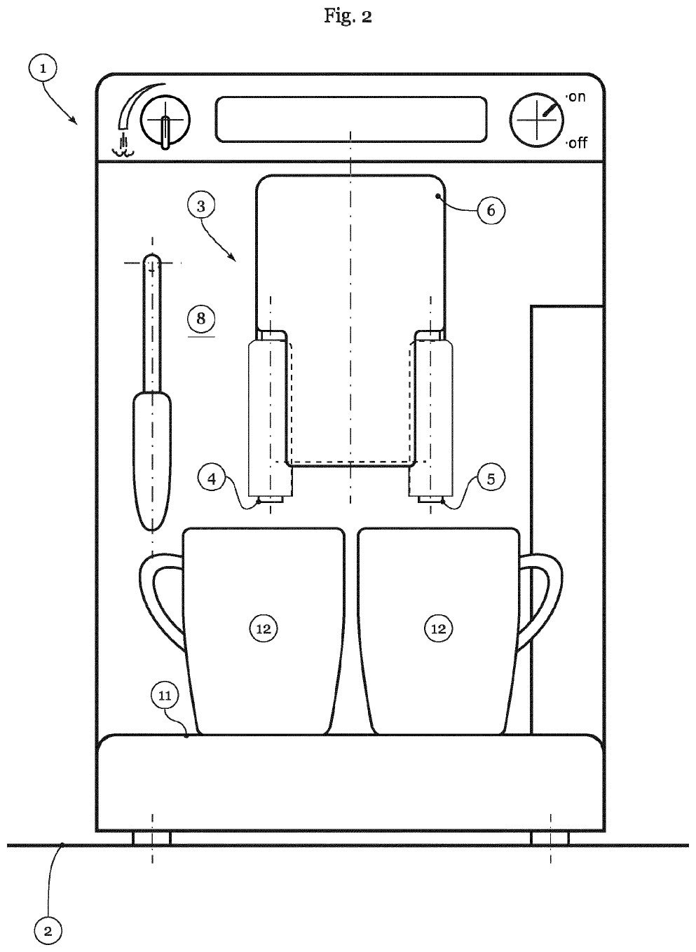

FIG. 2 schematically shows a front view of the coffee machine with the coffee dispensing spouts further from each other;

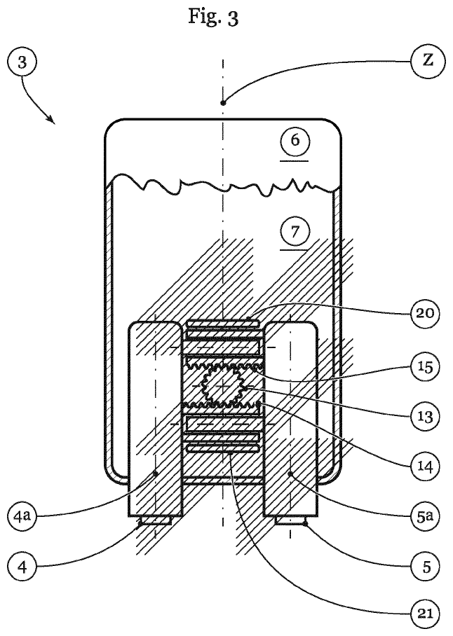

FIG. 3 schematically shows a front view of the coffee dispenser highlighting the mechanisms in the configuration corresponding to the position of the spouts illustrated in FIG. 1;

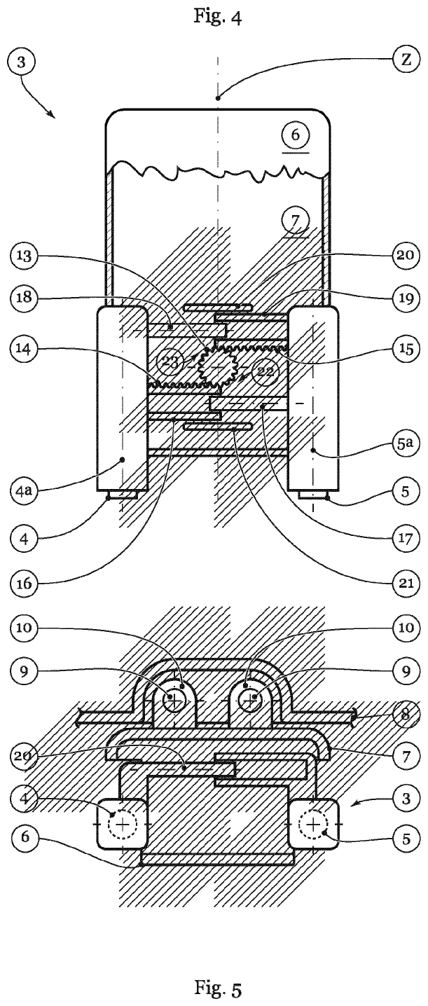

FIG. 4 schematically shows a front view of the coffee dispenser highlighting the mechanisms in the configuration corresponding to the position of the spouts illustrated in FIG. 2;

FIG. 5 schematically shows a plan view from above of the coffee dispenser, partially sectioned, highlighting the mechanisms in the same configuration as FIG. 4.

With reference to the figures cited, a coffee machine is shown and indicated in its entirety by reference number 1.

In the following description, the dimension in direction A of the height of the coffee machine 1 means the dimension in an orthogonal direction to the resting surface 2 of the coffee machine 1, the dimension in direction P of the depth of the coffee machine 1 means the dimension in an anteroposterior direction parallel to the resting surface 2, and the dimension in direction L of the width of the coffee machine 1 means the dimension in a parallel direction to the resting surface 2 and orthogonal to the direction P.

The coffee machine 1 has in a known way a hydraulic circuit (not shown) for producing coffee comprising in cascade a water supply pump, a boiler for heating water, an infuser unit for the infusion of coffee powder with hot water, and a dispenser of the coffee drink having two dispensing spouts 4, 5.

Obviously other different layouts of the coffee machine's hydraulic circuit fall within the scope of the invention as long as they have a coffee drink dispenser equipped with at least two dispensing spouts.

The dispenser comprises a support 3 having special translation guide means of the first and second spout 4, 5 in the direction L of the width of the coffee machine 1.

The support 3 also advantageously has a gear for synchronising the translation movement in the opposite sense to the first and second dispensing spout 4, 5 in the direction L of the width of the coffee machine 1, which will be described specifically below.

The support 3 has a hollow conformation and the synchronisation gear is mounted inside it.

The support 3 comprises in particular a front wall 6 and a rear wall 7 that perimetrally delimit the openings for the exit of the dispensing spouts 4, 5.

The support 3 is mounted on the front wall 8 of the coffee machine 1 preferably through translation guides 9, 10 in the direction A of the height of the coffee machine 1.

The translation guides 9, 10 by way of example envisage two rods 9 fixed to the front wall 8 of the coffee machine 1 and two bushings 10 fixed posteriorly to the rear wall 7 of the support 3 and threaded slidably onto the rods 9.

The coffee machine 1 has anteriorly in a known way a resting surface 11 for the cups 12 that extends below the spouts 4, 5 of the dispenser.

The synchronisation gear specifically comprises a pinion 13 engaging in diametrically opposite points with a first and a second rack 14, 15.

The pinion 13 has an axis oriented in the direction P of the depth of the coffee machine 1.

The first rack 14 is fixed to the first dispensing spout 4 and is oriented in the direction L of the width of the coffee machine 1.

The second rack 15 is fixed to the second dispensing spout 5 and is oriented in the direction L of the width of the coffee machine 1.

The first and second dispensing spout 4, 5 are arranged on the opposite side with respect to a plane Z of the support 3 oriented orthogonally to the direction L of the width of the coffee machine 1.

The pinion 13 is arranged at said plane Z which is in turn preferably a halfway plane of the support 3.

Advantageously, a deceleration means for decelerating the movement of said synchronisation gear is also provided.

The deceleration means comprises a clutch (not shown) integrated into the pinion 13.

The racks 14 and 15 in general may be provided on plates or bars slidably engaged along relevant translation guides solidly constrained to the support 3.

Instead, in the embodiment illustrated the first rack 14 is integrated into first guides 22 of mutual coupling between the first and the second spout 4, 5, and likewise the second rack 15 is integrated into second guides 23 of mutual coupling between the first and the second spout 4, 5. The first mutual coupling guides 22 comprise a rod 17 slidable in a tube 16 externally carrying the first rack 14, and likewise the second mutual coupling guides 23 comprise a rod 18 slidable in a tube 19 externally carrying the second rack 15. In this case, specific translation guides 20, 21 solidly constrained to the support 3 guide the tubes 16, 19 in the translation direction of the spouts 4, 5.

Naturally in other embodiments falling within the scope of the invention, the mutual coupling guides 22, 23 may also not be provided.

The support 3 is obviously equipped with a first limit stop (not shown) adapted to interact with the translation guides of the spouts or directly with the spouts at a position of maximum distance between the dispensing spouts 4, 5 in the direction of the width L of the coffee machine 1, and a second limit stop (not shown) adapted to interact with the translation guides of the spouts or directly with the spouts at a position of minimum distance between the dispensing spouts 4, 5 in the direction of the width of the coffee machine 1.

Before dispensing the coffee, if necessary, the dispenser is adjusted in height by sliding it along its translation guides 9, 10.

For the adjustment of the centring of the coffee in the cup according to the use of one or simultaneously two cups 12, with the support 3 stationary, the user can directly pull just one of the two dispensing spouts 4, 5 given that the other one moves in a synchronised manner.

Obviously for dispensing into a single cup 12 the dispensing spouts 4, 5 must be moved closer to each other, whereas for simultaneous dispensing into two cups 12 the dispensing spouts must be moved away from each other more so the larger the diameter of the cups 12.

When the desired distance is achieved between the dispensing spouts 4, 5 the user releases the grip and the synchronisation gear remains in the position achieved due to the effect of the action of the pinion 13 clutch.

The coffee machine as conceived herein is susceptible to many modifications and variations, all falling within the scope of the inventive concept; furthermore, all the details are replaceable by technically equivalent elements.

In practice the materials used, as well as the dimensions, can be any according to needs and the state of the art.

1. A coffee machine (1) comprising a coffee dispenser having a support (3), a first spout (4) for dispensing coffee supported by said support (3), at least a second spout (5) for dispensing coffee supported by said support (3), wherein said support (3) has translation guides for translating said first and said second dispensing spout (4, 5) in a direction (L) of a width of the coffee machine (1), and a gear for synchronizing translation movement in a opposite sense to said first and said second dispensing spout (4, 5) in the direction (L) of the width of the coffee machine (1).

2. The coffee machine (1) according to claim 1, wherein said synchronization gear comprises a pinion (13) engaging in diametrically opposite points with a first and a second rack (14, 15), said pinion (13) having an axis oriented in a direction (P) of a depth of the coffee machine (1), said first rack (14) being fixed to said first dispensing spout (4) and being oriented in the direction (L) of the width of the coffee machine (1), said second rack (15) being fixed to said second dispensing spout (5) and being oriented in the direction (L) of the width of the coffee machine (1).

3. The coffee machine (1) according to claim 2, wherein said first and said second dispensing spout (4, 5) are arranged on an opposite side with respect to a plane (Z) of said support (3) oriented orthogonally to the direction (L) of the width of the coffee machine (1) and said pinion (13) is arranged at said plane (Z).

4. The coffee machine (1) according to claim 2, further comprising a deceleration means for decelerating movement of said synchronization gear.

5. The coffee machine (1) according to claim 4, wherein said deceleration means comprises a clutch integrated into said pinion (13).

6. The coffee machine (1) according to claim 1, wherein said support (3) is mounted on translation guides (9, 10) in a direction (A) of a height of the coffee machine (1).

7. The coffee machine (1) according to claim 2, wherein said racks (14, 15) are provided on plates or bars slidably engaged along said translation guides of said first and said second dispensing spouts (4, 5).

8. The coffee machine (1) according to claim 2, wherein said first and said second rack (14, 15), respectively, are integrated in first (22) and second (23) guides, respectively, of mutual coupling between said first and said second dispensing spout (4, 5).

9. The coffee machine (1) according to claim 8, wherein each of said first and said second mutual coupling guides (22, 23) comprises a rod (17, 18) slidable in a tube (16, 19) externally carrying a respective rack (14, 15).

10. A centring method for dispensing coffee in a coffee machine (1), the coffee machine comprising at least two spouts (4, 5) for dispensing coffee, the method comprising the step(s) of translating in an opposite sense in a synchronized way said two spouts (4, 5), in a direction (L) of a width of the coffee machine (1), maintaining an axis (4a, 5a) of said two spouts (4,5) permanently oriented in a direction (A) of a height of the coffee machine (1), between a position of maximum mutual distance in the direction (L) of the width of the coffee machine (1), and a position of minimum mutual distance in the direction (L) of the width of the coffee machine (1).
